(19) United States
(12) Patent Application Publication
(10) Pub. No.: US 2008/0132614 A1
(43) Pub. Date: Jun. 5, 2008

(54) Polycarbonate Resin Composition with Good Light Reflectance

(75) Inventors: Hyuk Jin JUNG, Gunpo-si (KR); Jong Cheol LIM, Anyang-si (KR); Tae Gon KANG, Suwon-si (KR)

Correspondence Address: SUMMA, ALLAN & ADDITON, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 11/965,988

(22) Filed: Dec. 28, 2007

Related U.S. Application Data
(63) Continuation-in-part of application No. PCT/KR2005/002252, filed on Jul. 13, 2005.

(30) Foreign Application Priority Data
Jun. 30, 2005 (KR) 10-2005-0057881

(51) Int. Cl. C08K 5/34

(52) U.S. Cl. 524/100; 524/432; 524/502; 524/106

(57) ABSTRACT

The present invention relates to a polycarbonate resin composition that comprises (A) about 50 to about 95 parts by weight of a polycarbonate resin, (B) about 5 to about 50 parts by weight of a poly(meth)acrylic acid alkyl ester resin, (C) about 1 to about 30 parts by weight of a titanium dioxide, (D) about 1 to about 50 parts by weight of a vinyl graft copolymer prepared by graft-polymerizing (d₁) about 5 to about 95 parts by weight of a monomer mixture comprising (d₁₁) about 50 to about 95 parts by weight of styrene, α-methylstyrene, halogen- or C₁-C₈ alkyl-substituted styrene, C₁-C₈ methacrylic acid alkyl ester, C₁-C₈ acrylic acid alkyl ester or a mixture thereof and (d₁₂) about 5 to about 50 parts by weight of acrylonitrile, methacrylonitrile, C₁-C₈ methacrylic acid alkyl ester, C₁-C₈ acrylic acid alkyl ester, maleic anhydride, C₁-C₄ alkyl- or phenyl N-substituted maleimide or a mixture thereof onto (d₂) about 5 to about 95 parts by weight of a rubber polymer selected from the group consisting of acryl rubber, ethylene-propylene rubber, polyorganosiloxane-polyalkyl(meth)acrylate rubber and mixtures thereof, and (E) about 0.1 to about 3 parts by weight of a UV absorbent.

### CROSS REFERENCE TO RELATED APPLICATIONS

This non-provisional application is a continuation-in-part application of PCT Application No. PCT/KR2005/002252, filed Jul. 13, 2005, pending, which designates the U.S., and which is hereby incorporated by reference in its entirety, and also claims priority from Korean Patent Application No. 10-2005-0057881, filed Jun. 30, 2005, which is also hereby incorporated by reference in its entirety.

### FIELD OF THE INVENTION

The present invention relates to a polycarbonate resin composition.

### BACKGROUND OF THE INVENTION

Polycarbonate resin is an engineering plastic that has excellent mechanical strength, heat resistance and transparency. Therefore, the resin is widely used in the production of office supplies, electric or electronic goods, construction materials, and the like. However, polycarbonate resin has poor processability and notched impact strength.

To overcome these shortcomings, polycarbonate resin can be blended with other polymer resin(s). For example, a resin composition including a blend of a polycarbonate resin and an acrylonitrile-butadiene-styrene (ABS) grafted polymer can have improved processability and maintain good notched impact strength.

In the field of electric or electronic goods, high light reflectance, light resistance, and colorability, among other properties, are required for resins that are used to produce back-light parts of LCDs (Liquid Crystalline Displays). Flowability is also required for the resin because electronic goods (e.g. televisions, monitors, notebooks, etc.) are becoming increasingly thinner.

Polycarbonate resins can be used to produce back-light parts of LCDs, for example, back-light frames, and the resin is colored with high white to minimize back-light loss upon reflectance. Thus titanium dioxide (TiO₂) which has the largest refraction index in air is largely employed as a white pigment for coloring the resin to provide a high white color.

Japanese Patent Publication No. 63-26,140 discloses a polycarbonate resin composition employing a titanium dioxide for reflection index. However, the titanium oxide also transmits light and thus the composition exhibits decreased brightness and color fastness. Also, the composition can exhibit decreased fluidity during processing, which can result in defects on a surface of a product produced from the composition.

Japanese Patent Publication No. H09-012,853 discloses a flame retardant resin composition that comprises a polycarbonate resin, a titanium dioxide, a polyorganosiloxane-polyalkylacrylate rubber, a flame retardant and a polytetrafluoroethylene resin, and U.S. Pat. No. 5,837,757 discloses a flame retardant resin composition that comprises a polycarbonate resin, a titanium dioxide, a stilbene-bisbenzoxazole derivative and a phosphoric acid ester compound.

These resin compositions can maintain high light reflectance before contact with the back-light source of a LCD. However, after contact with a light source for a long time, the light reflectance is decreased due to yellowing.

### SUMMARY OF THE INVENTION

The present inventors have developed a polycarbonate resin composition that comprises a polycarbonate resin, a poly(meth)acrylic acid alkyl ester resin, a titanium dioxide, a impact modifier and a UV absorbent having a specific structure, which can have good light reflectance after UV irradiation. The polycarbonate resin composition can also have good light resistance and exhibit minimal yellowing and further can maintain good mechanical strength, impact resistance, flowability, processability, appearance, and other desirable properties.

The polycarbonate resin composition can include (A) about 50 to about 95 parts by weight of a polycarbonate resin, (B) about 5 to about 50 parts by weight of a poly(meth)acrylic acid alkyl ester resin, (C) about 1 to about 30 parts by weight of a titanium dioxide, (D) about 1 to about 50 parts by weight of a vinyl graft copolymer prepared by graft-polymerizing (d₁) about 5 to about 95 parts by weight of a monomer mixture comprising (d₁₁) about 50 to about 95 parts by weight of styrene, α-methylstyrene, halogen or C₁-C₈ alkyl-substituted styrene, C₁-C₈ methacrylic acid alkyl ester, C₁-C₈ acrylic acid alkyl ester or a mixture thereof and (d₁₂) about 5 to about 50 parts by weight of acrylonitrile, methacrylonitrile, C₁-C₈ methacrylic acid alkyl ester, C₁-C₈ acrylic acid alkyl ester, maleic anhydride, C₁-C₄ alkyl- or phenyl N-substituted maleimide or a mixture thereof onto (d₂) about 5 to about 95 parts by weight of a rubber polymer selected from the group consisting of acryl rubber, ethylene-propylene rubber, polyorganosiloxane-polyalkyl(meth)acrylate rubber and mixtures thereof, and (E) about 0.1 to about 3 parts by weight of a UV absorbent.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The components of the polycarbonate resin composition according to the present invention are described in detail as follows:

### (A) Polycarbonate Resin

The polycarbonate resin can be prepared by a diphenol represented by the following chemical formula (I) with a phosgene, a halogen formate or a carboxylic acid diester:

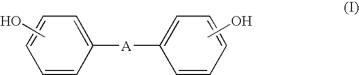

wherein A is a single bond, a C₁-C₅ alkylene group, C₁-C₅ alkylidene group, C₅-C₆ cycloalkylidene group, S or SO₂.

Examples of diphenols suitable for use in the present invention can include without limitation hydroquinone, resorcinol, 4,4′-dihydroxydiphenol, 2,2-bis-(4-hydroxyphenyl)-propane, 2,4-bis-(4-hydroxyphenyl)-2-methylbutane, 1,1-bis-(4-hydroxyphenyl)-cyclohexane, 2,2-bis-(3-chloro-4-hydroxyphenyl)-propane (‘bisphenol A’), 2,2-bis-(3,5-dichloro-4-hydroxyphenyl)-propane, and the like, and mixtures thereof.

In the present invention, the polycarbonate resin (A) can have a weight average molecular weight (M_{w}) of about 10,000 to about 200,000, for example about 15,000 to about 80,000.

Suitable polycarbonates incorporated into the composition of the present invention may be branched in a known manner, for example by incorporation of about 0.05 to about 2 mol %, based to total quantity of diphenols used, of tri- or higher functional compounds, for example, those with three or more phenolic groups.

A homopolymer of polycarbonate, a copolymer of polycarbonate or a mixture thereof may be used in this invention.

Also, some portion of the polycarbonate resin may be replaced with an aromatic polyester-carbonate resin that is obtained by polymerization in the presence of an ester precursor, such as a difunctional carboxylic acid.

The polycarbonate resin composition of the present invention can include the polycarbonate resin (A) in an amount of about 50 to about 95 parts by weight. If the polycarbonate resin (A) is used in an amount of less than about 50 parts by weight, impact resistance and heat resistance may deteriorate.

### (B) Poly(meth)acrylic Acid Alkyl Ester Resin

The poly(meth)acrylic acid alkyl ester resin can be prepared by bulk, emulsion, suspension or solution polymerization of a monomer such as C₁-C₈ acrylic acid alkyl ester or C₁-C₈ methacrylic acid alkyl ester represented by the following chemical formula (I 1):

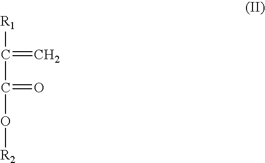

wherein R₁ is H or methyl and R₂ is a C₁-C₈ alkyl group.

The C₁-C₈ methacrylic acid alkyl ester is obtained from methacrylic acid and monohydryl alcohol containing 1 to 8 carbon atoms and the C₁-C₈ acrylic acid alkyl ester is obtained from acrylic acid and monohydryl alcohol containing 1 to 8 carbon atoms. Examples of acid alkyl esters suitable for use in the present invention can include without limitation methacrylic acid methyl ester, methacrylic acid ethyl ester, acrylic acid ethyl ester, methacrylic acid propyl ester, and the like, and mixtures thereof.

In the present invention the poly(meth)acrylic acid alkyl ester resin (B) can have a weight average molecular weight (Mw) of about 10,000 to about 500,000, for example about 15,000 to about 350,000.

The polycarbonate resin composition of the present invention can include the poly(meth)acrylic acid alkyl ester resin (B) an amount of about 5 to about 50 parts by weight. If the poly(meth)acrylic acid alkyl ester resin (B) is used in an amount less than about 5 parts by weight, it can be difficult to obtain desired light reflectance after UV irradiation. On the other hand, if the poly(meth)acrylic acid alkyl ester resin (B) is used in an amount in excess of about 50 parts by weight, impact resistance and heat resistance may deteriorate.

### (C) Titanium Dioxide

In the present invention, a conventional titanium dioxide can be used as the titanium dioxide (C), and methods of making the same and the size thereof are not limited. In the present invention, the titanium dioxide (C) can be surface-treated with an inorganic or organic surface treating agent.

Examples of inorganic surface treating agents suitable for use in the present invention can include without limitation aluminium oxide (alumina, Al₂O₃), silicon dioxide (silica, SiO₂), zirconia (zirconium dioxide, ZrO₂), sodium silicate, sodium aluminate, sodium aluminium silicate, mica, and the like, and mixtures thereof.

Examples of organic surface treating agents suitable for use in the present invention can include without limitation polydimethylsiloxane, trimethylpropane (TMP), pentaerythritol, and the like, and mixtures thereof. The titanium dioxide (C) can be coated with the surface treating agent in an amount of about 0.3 parts by weight per 100 parts by weight of the titanium dioxide.

As an example, in the present invention, titanium dioxide coated with less than about 2 parts by weight of alumina (Al₂O₃) can be used.

Also, the titanium dioxide coated with alumina can be further modified by an inorganic surface treatment agent such as silicon dioxide, zirconium dioxide, sodium silicate, sodium aluminate, sodium aluminium silicate and mica, and the like and an organic surface treatment agent such as polydimethylsiloxane, trimethylpropane (TMP), pentaerythritol and the like and can be used in the present invention.

The polycarbonate resin composition of the present invention can include the titanium dioxide (C) in an amount of about 1 to about 30 parts by weight. If the titanium dioxide (C) is used in an amount less than about 1 part by weight, it can be difficult to obtain desired light reflectance after UV irradiation. On the other hand, if the titanium dioxide (C) is used in an amount in excess of about 30 parts by weight, impact resistance can deteriorate.

### (D) Rubber Modified Vinyl Graft Copolymer

The rubber modified vinyl graft copolymer (D) according to the present invention can be prepared by graft-polymerizing (d₁) about 5 to about 95 parts by weight of a monomer mixture comprising (d₁₁) about 50 to about 95 parts by weight of styrene, α-methylstyrene, halogen- or C₁-C₈ alkyl-substituted styrene, C₁-C₈ methacrylic acid alkyl ester, C₁-C₈ acrylic acid alkyl ester or a mixture thereof and (d₁₂) about 5 to about 50 by weight of acrylonitrile, methacrylonitrile, C₁-C₈ methacrylic acid alkyl ester, C₁-C₈ acrylic acid alkyl ester, maleic anhydride, C₁-C₄ alkyl- or phenyl N-substituted maleimide or a mixture thereof ((d₁₂ includes a monomer that is different from the monomer of (d₁₁)) onto (d₂) about 5 to about 95 parts by weight of a rubber polymer selected from the group consisting of acryl rubber, ethylene-propylene rubber, polyorganosiloxane-polyalkyl(meth)acrylate rubber and mixtures thereof.

The C₁-C₈ methacrylic acid alkyl ester is obtained from methacrylic acid and monohydryl alcohol containing 1 to 8 carbon atoms and the C₁-C₈ acrylic acid alkyl ester is obtained from acrylic acid and monohydryl alcohol containing 1 to 8 carbon atoms. Examples of C₁-C₈ methacrylic acid alkyl esters suitable for use in the present invention can include without limitation methacrylic acid methyl ester, methacrylic acid ethyl ester, acrylic acid ethyl ester, methacrylic acid propyl ester, and the like, and mixtures thereof.

Examples of the vinyl graft copolymer (D) include those prepared by polymerizing a butylacrylate rubber with a monomer mixture consisting of styrene, acrylonitrile and optionally (meth)acrylic acid alkyl ester monomer.

Other examples of the vinyl graft copolymer (D) include those prepared by polymerizing an acrylic rubber or a polyorganosiloxane/polyalkyl(meth)acrylate rubber complex with a (meth)acrylic acid methyl ester or optionally a monomer mixture with acrylic acid methyl ester or acrylic acid ethyl ester.

The size of the rubber polymer (d₂) of the present invention can range from about 0.05 to about 4 μm to improve impact resistance and surface features of the resultant product.

The graft copolymer according to the present invention can be prepared through a conventional polymerization process such as bulk, emulsion, suspension, and solution processes. As an example, the graft copolymer can be prepared by emulsion or bulk polymerization in which the aromatic vinyl monomers are added to the rubber polymer using a polymerization initiator.

The polycarbonate resin composition of the present invention can include the rubber modified vinyl graft copolymer (D) in an amount of about 1 to about 50 parts by weight. If the vinyl graft copolymer (D) is used in an amount of less than about 1 part by weight, impact resistance can deteriorate. On the other hand, if the vinyl graft copolymer (D) is used in an amount in excess of about 50 parts by weight, heat resistance and light reflectance can deteriorate.

### (E) UV Absorbent

In the present invention, a benzotriazole, a benzophenone or a triazine compound represented by the following chemical formula (III), (IV) and (V) respectively can be used as a UV absorbent.

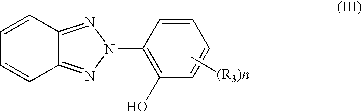

wherein R₃ is a C₁-C₁₀ alkyl group or C₁-C₈ alkyl-substituted phenyl and n is 1 or 2.

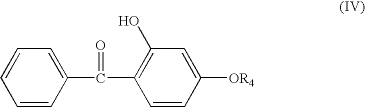

wherein R₄ is H, a C₁-C₁₅ alkyl group or C₁-C₈ alkyl-substituted phenyl.

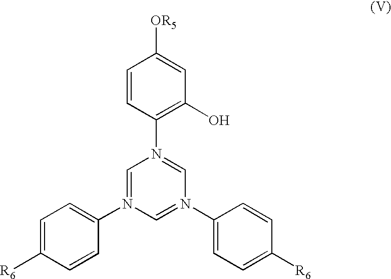

wherein R₅ is H, a C₁-C₁₈ alkyl group, a C₂-C₆ halogen-substituted alkyl group, a C₁-C₁₂ alkoxy group or benzyl group and R₆ is H or methyl.

Examples of the benzotriazol based UV absorbent suitable for use in the present invention can include without limitation 2-(2′-hydroxy-5′-methylphenyl)benzotriazole, 2-[2′-hydroxy-3′,5′-bis(α,α-dimethylbenzyl)phenyl]benzotriazole, 2-(2′-hydroxy-3′,5′-di-t-butylphenyl)benzotriazole, 2-(2′-hydroxy-3′-t-butyl-5′-methylphenyl)-5-chlorobenzotriazole, 2-(2′-hydroxy-3′,5′-di-t-butylphenyl)-5-chlorobenzotriazole, 2-(2′-hydroxy-3′,5′-di-t-amyl)benzotriazole, 2-(2′-hydroxy-5′-t-octylphenyl)benzotriazole, 2,2′-methylene-bis[4-(1,1,3,3,-tetramethylbutyl)-6-(2N-benzotriazol-2-yl)phenol], and the like, and mixtures thereof.

Examples of the benzophenone based UV absorbent suitable for use in the present invention can include without limitation 2,4-hydroxybenzophenone, 2,4-hydroxy-4-methoxybenzophenone, 2,4-hydroxy-4-methoxybenzophenon-5-sulfonic acid, 2,4-hydroxy-4-n-octyloxybenzophenone, 2,4-hydroxy-4-n-dodecyloxybenzophenone, bis(5-benzoyl′-4-hydroxy-2-methoxyphenyl)methane, 2,2′-dihydroxy-4-methoxybenzophenone, 2,2′-dihydroxy-4,4′-dimethoxybenzophenone, and the like, and mixtures thereof.

Examples of the triazine based UV absorbent suitable for use in the present invention can include without limitation 2,4-diphenyl-6-(2-hydroxy-4-methoxyphenyl)-1,3,5-triazine, 2,4-diphenyl-6-(2-hydroxy-4-ethoxyphenyl)-1,3,5-triazine, 2,4-diphenyl-6-(2-hydroxy-4-propoxyphenyl)-1,3,5-triazine, 2,4-diphenyl-6-(2-hydroxy-4-butoxyphenyl)-1,3,5-triazine, 2,4-diphenyl-6-(2-hydroxy-4-hexyloxyphenyl)-1,3,5-triazine, 2,4-diphenyl-6-(2-hydroxy-4-pentoxyphenyl)-1,3,5-triazine, 2,4-diphenyl-6-(2-hydroxy-4-octyloxyphenyl)-1,3,5-triazine, 2,4-diphenyl-6-(2-hydroxy-4-dodecyloxyphenyl)-1,3,5-triazine, 2,4-diphenyl-6-(2-hydroxy-4-benzyloxyphenyl)-1,3,5-triazine, 2,4-diphenyl-6-(2-hydroxy-4-(2-butoxyethoxy)phenyl)-1,3,5-triazine, 2,4-di-p-tolyl-6-(2-hydroxy-4-propoxyphenyl)-1,3,5-triazine, 2,4-di-p-tolyl-6-(2-hydroxy-4-butoxyphenyl)-1,3,5-triazine, 2,4-di-p-tolyl-6-(2-hydroxy-4-hexyloxyphenyl)-1,3,5-triazine, 2,4-di-p-tolyl-6-(2-hydroxy-4-pentoxyphenyl)-1,3,5-triazine, 2,4-di-p-tolyl-6-(2-hydroxy-4-octyloxyphenyl)-1,3,5-triazine, 2,4-di-p-tolyl-6-(2-hydroxy-4-benzyloxyphenyl)-1,3,5-triazine, 2,4-di-p-tolyl-6-(2-hydroxy-4-(2-hexyloxyethoxy)phenyl)-1,3,5-triazine, and the like, and mixtures thereof.

The polycarbonate resin composition of the present invention can include the UV absorbent (E) in an amount of about 0.1 to about 3 parts by weight. If the UV absorbent (E) is used in an amount less than about 0.1 parts by weight, light reflectance can deteriorate. On the other hand, if the UV absorbent (E) is used in an amount in excess of about 3 parts by weight, impact resistance and heat resistance can deteriorate.

The polycarbonate resin composition of the invention having good light reflectance can include other additives, depending on the end use of the composition. Examples of other additives suitable for use in the present invention can include without limitation a fluorescent brightener, a flame retardant, a flame retardant aid, a lubricant, a releasing agent, a nuclear agent, an anti-static agent, a stabilizer, a reinforcing agent, an inorganic additive, a pigment, a dye, and the like, and mixtures thereof. The polycarbonate resin composition of the present invention can include the additives in an amount of about to about 60 parts by weight, for example, about 1 to about 40 parts by weight, per 100 parts by weight of the base resin.

A stilbene-bisbenzoxazole derivative can be used as a fluorescent brightener to improve light reflectance of the polycarbonate resin composition. Examples of stilbene-bisbenzoxazole derivatives suitable for use in the present invention can include without limitation 4-(benzoxazole-2-yl)-4′-(5-methylbenzoxazole-2-yl)stilbene[4-(benzoxazole-2-yl)-4′-(5-methylbenzoxazol-2-yl)stilbene], 4,4′-bis(benzoxazole-2-yl)stilbene[4,4′-bis(benzoxazole-2-yl)stilbene], and the like, and mixtures thereof.

The polycarbonate resin composition according to the present invention can be prepared by a conventional method. As a non-limiting example, all the components and additives can be mixed together and extruded through an extruder and prepared in the form of pellets.

According to the present invention, the polycarbonate resin composition can be useful for the manufacture of various goods, particularly electric or electronic goods such as back-light parts of LCDs which require high light reflectance and processability.

The invention may be better understood by reference to the following examples which are for the purpose of illustration and are not to be construed as in any way limiting the scope of the present invention, which is defined in the claims appended hereto. In the following examples, all parts and percentage are by weight unless otherwise indicated.

### EXAMPLES

### (A) Polycarbonate Resin

Bisphenol-A type linear polycarbonate resin with a weight average molecular weight (M_{w}) of 25,000 g/mol manufactured by TEIJIN (product name: PANLITE L-1250 WP) is used.

### (B) Poly(meth)acrylic Acid Alkyl Ester Resin

Polymethylmethacrylate manufactured by LG MMA (product name: IF-850) is used.

### (C) Titanium Dioxide

Titanium dioxide manufactured by Millennium of America (product name: TIONA RL-91) is used.

### (D) Rubber Modified Vinyl Graft Copolymer

(d₁) Metablen S2001 by MRC of Japan prepared by graft polymerizing methacrylic acid methyl ester monomer onto a rubber mixture consisting of polybutylacrylate and polydimethylsiloxane rubber is used.

(d₂) EM-100 by LG Chemical of Korea prepared by graft polymerizing methacrylic acid methyl ester monomer onto polybutylacrylate rubber is used.

(d₃) Paraloid EXL-2602 by Rohm & Haas of U.S.A. prepared by graft polymerizing methacrylic acid methyl ester monomer onto polybutadiene rubber is used.

### (E) UV Absorbent

2-(4,6-diphenyl-1,3,5-triazine-2-yl)-5-hexyloxyphenol manufactured by Ciba of Switzerland (product name: Tinuvin 1577FF) is used.

### Examples 1-4

The components as shown in Table 1 are mixed in a conventional mixer, to which are added antioxidant and heat stabilizer and the mixture is extruded through a twin screw extruder with L/D=35, Φ=45 mm to prepare a product resin in pellet form. The resin pellets are molded into test specimens using a 10 oz injection molding machine at an injection temperature of 250° C. These test specimens are measured in accordance with ASTM standards as described below after leaving the specimens at 23° C. and 50% relative humidity for 48 hours.

(1) The light reflectance and the yellow index are measured by ASTM G53 UV Condensation machine and Minolta 3600D CIE Lab. Color difference meter, for before and after UV irradiation.

(2) The notch IZOD impact strength (kgf·cm/cm) is measured in accordance with ASTM D256.

(3) The melt flow index is measured in accordance with ASTM D1238 at 250° C., 10 kgf.

### Comparative Example 1

Comparative example 1 is prepared conducted in the same manner as in Example 1 except that a poly(meth)acrylic acid alkyl ester resin (B) is not used and the amount of the polycarbonate resin (A) is 100 parts by weight.

### Comparative Example 2

Comparative example 2 is prepared in the same manner as in Example 1 except that Paraloid EXL-2602 resin (d₃) is used as a rubber modified vinyl graft copolymer (D).

### Comparative Example 3

Comparative example 3 is prepared in the same manner as in Example 3 except that a titanium dioxide (C) is not used.

### Comparative Example 4

Comparative example 4 is prepared in the same manner as in Example 2 except that a UV absorbent (E) is not used.

### Comparative Example 5

Comparative example 5 is prepared in the same manner as in Example 1 except that a polycarbonate resin (A) and a poly(meth)acrylic acid alkyl ester resin (B) are used in amounts outside of the range of the present invention.

The test results of the components of example 1-4 and comparative example 1-5 are shown in Table 1.

TABLE 1

| | | Example | | | | Comparative Example | | | | |
|---|---|---|---|---|---|---|---|---|---|---|
| | | 1 | 2 | 3 | 4 | 1 | 2 | 3 | 4 | 5 |
| (A) Polycarbonate Resin | | 60 | 70 | 90 | 70 | 100 | 60 | 90 | 70 | 10 |
| (B) Poly(meth)acrylic Acid Alkyl Ester Resin | | 40 | 30 | 10 | 30 | — | 40 | 10 | 30 | 90 |
| (C) Titanium Dioxide | | 10 | 10 | 10 | 10 | 10 | 10 | — | 10 | 10 |
| (D) Rubber Modified Vinyl | (d₁) | 10 | 8 | 3 | — | 10 | — | 3 | 8 | 10 |
| Graft Copolymer | | | | | | | | | | |
| | (d₂) | — | — | — | 8 | — | — | — | — | — |
| | (d₃) | — | — | — | — | — | 10 | — | — | — |
| (E) UV Absorbent | | 1 | 1 | 1 | 1 | 1 | 1 | 1 | — | 1 |
| Light Reflectance | Before UV | 95.0 | 94.5 | 95.0 | 94.3 | 93.8 | 94.0 | 46.1 | 94.6 | 95.4 |
| (400-700 nm) | irradiation | | | | | | | | | |
| | After UV irradiation | 93.1 | 92.7 | 92.1 | 92.4 | 88.3 | 85.2 | 38.4 | 84.1 | 93.3 |
| | for 24 h | | | | | | | | | |
| Yellow Index | Before UV | 2.46 | 2.50 | 2.45 | 2.48 | 2.38 | 2.54 | 2.41 | 1.17 | 2.25 |
| | irradiation | | | | | | | | | |
| | After UV irradiation | 7.21 | 7.52 | 8.63 | 7.38 | 12.45 | 14.51 | 13.27 | 14.18 | 10.45 |
| | for 24 h | | | | | | | | | |

| | | | | | | | | | |
|---|---|---|---|---|---|---|---|---|---|
| IZOD Impact Strength (1/8″) | 68 | 72 | 73 | 71 | 74 | 65 | 71 | 73 | 7 |
| Melt Flow Index | 43 | 32 | 21 | 30 | 21 | 41 | 18 | 32 | 110 |

As shown in Table 1, for Comparative Example 1, which does not include a poly(meth)acrylic acid alkyl ester resin (B), the light reflectance is deteriorated and the yellow index is greatly increased after UV irradiation for 24 hours.

Comparative Example 2 using component (d₃) instead of component (d₁) shows that the light reflectance is deteriorated and that yellow index is increased after UV irradiation for 24 hours.

Comparative Example 3 which does not use titanium dioxide (C) shows that the light reflectance is greatly deteriorated and that yellow index is greatly increased after UV irradiation for 24 hours.

Also, for Comparative Example 4, which does not include a UV absorbent (E), the light reflectance is deteriorated and yellow index is greatly increased after UV irradiation for 24 hours.

For Comparative Example 5, wherein polycarbonate resin (A) and poly(meth)acrylic acid alkyl ester resin (B) was used in an amount outside of the range of the present invention., the IZOD impact strength is greatly deteriorated.

The data demonstrates that the polycarbonate resin composition of the present invention that comprises a polycarbonate resin, a poly(meth)acrylic acid alkyl ester resin, a titanium dioxide, an impact modifier and a UV absorbent having a specific structure, can have good light reflectance and lower or reduced color change after UV irradiation while maintaining good IZOD impact strength and melt flow index.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

1. A polycarbonate resin composition comprising:
(A) about 50 to about 95 parts by weight of a polycarbonate resin;
(B) about 5 to about 50 parts by weight of a poly(meth)acrylic acid alkyl ester resin;
(C) about 1 to about 30 parts by weight of a titanium dioxide;
(D) about 1 to about 50 parts by weight of a vinyl graft copolymer prepared by graft-polymerizing (d₁) about 5 to about 95 parts by weight of a monomer mixture comprising (d₁₁) about 50 to about 95 parts by weight of styrene, α-methylstyrene, halogen- or C₁-C₈ alkyl-substituted styrene, C₁-C₈ methacrylic acid alkyl ester, C₁-C₈ acrylic acid alkyl ester or a mixture thereof and (d₁₂) about 5 to about 50 parts by weight of acrylonitrile, methacrylonitrile, C₁-C₈ methacrylic acid alkyl ester, C₁-C₈ acrylic acid alkyl ester, maleic anhydride, C₁-C₄ alkyl- or phenyl N-substituted maleimide or a mixture thereof onto (d₂) about 5 to about 95 parts by weight of a rubber polymer selected from the group consisting of acryl rubber, ethylene-propylene rubber, polyorganosiloxane-polyalkyl(meth)acrylate rubber and mixtures thereof, and
(E) about 0.1 to about 3 parts by weight of a UV absorbent.

2. The polycarbonate resin composition according to claim 1, wherein said poly(meth)acrylic acid alkyl ester resin (B) is polymethylmethacrylate resin.

3. The polycarbonate resin composition according to claim 1, wherein said titanium dioxide (C) is surface-treated with at least one surface treating agent selected from the group consisting of inorganic surface treating agents, organic surface treating agents, and mixtures thereof.

4. The polycarbonate resin composition according to claim 1, wherein said C₁-C₈ methacrylic acid alkyl ester is selected from the group consisting of methacrylic acid methyl ester, methacrylic acid ethyl ester, methacrylic acid propyl ester, and mixtures thereof.

5. The polycarbonate resin composition according to claim 1, wherein said C₁-C₈ acrylic acid alkyl ester is acrylic acid ethyl ester.

6. The polycarbonate resin composition according to claim 1, wherein said UV absorbent (E) is selected from the group consisting of:
benzotriazoles represented by Chemical Formula (III) 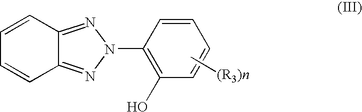
wherein R₃ is a C₁-C₁₀ alkyl group or alkyl-substituted phenyl and n is 1 or 2;
benzophenones represented by Chemical Formula (IV) 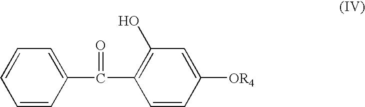
wherein R₄ is H, a C₁-C₁₅ alkyl group or alkyl-substituted phenyl;
triazines represented by Chemical Formula (V) 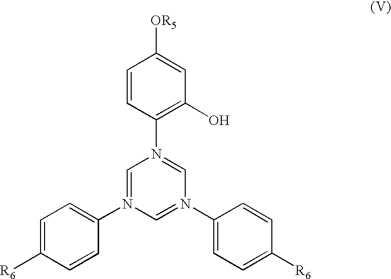
wherein R₅ is H, a C₁-C₁₈ alkyl group, a C₂-C₆ halogen-substituted alkyl group, a C₁-C₁₂ alkoxy group or benzyl group; and R₆ is H or methyl; and
mixtures thereof.

7. The polycarbonate resin composition according to claim 1, further comprising up to about 60 parts by weight of an additive selected from the group consisting of fluorescent brighteners, flame retardants, flame retardant aids, lubricants, releasing agents, nuclear agents, anti-static agents, stabilizers, reinforcing agents, inorganic additives, pigments, dyes and mixtures thereof.

8. A molded article produced from a polycarbonate resin composition comprising:
(A) about 50 to about 95 parts by weight of a polycarbonate resin;
(B) about 5 to about 50 parts by weight of a poly(meth)acrylic acid alkyl ester resin;
(C) about 1 to about 30 parts by weight of a titanium dioxide;
(D) about 1 to about 50 parts by weight of a vinyl graft copolymer prepared by graft-polymerizing (d₁) about 5 to about 95 parts by weight of a monomer mixture comprising (d₁₁) about 50 to about 95 parts by weight of styrene, α-methylstyrene, halogen- or C₁-C₈ alkyl-substituted styrene, C₁-C₈ methacrylic acid alkyl ester, C₁-C₈ acrylic acid alkyl ester or a mixture thereof and (d₁₂) about 5 to about 50 parts by weight of acrylonitrile, methacrylonitrile, C₁-C₈ methacrylic acid alkyl ester, C₁-C₈ acrylic acid alkyl ester, maleic anhydride, C₁-C₄ alkyl- or phenyl N-substituted maleimide or a mixture thereof onto (d₂) about 5 to about 95 parts by weight of a rubber polymer selected from the group consisting of acryl rubber, ethylene-propylene rubber, polyorganosiloxane-polyalkyl(meth)acrylate rubber and mixtures thereof, and
(E) about 0.1 to about 3 parts by weight of a UV absorbent.

9. The molded article according to claim 8, wherein said poly(meth)acrylic acid alkyl ester resin (B) is polymethylmethacrylate resin.

10. The molded article according to claim 8, wherein said titanium dioxide (C) is surface-treated with at least one surface treating agent selected from the group consisting of inorganic surface treating agents, organic surface treating agents, and mixtures thereof.

11. The molded article according to claim 8, wherein said C₁-C₈ methacrylic acid alkyl ester is selected from the group consisting of methacrylic acid methyl ester, methacrylic acid ethyl ester, methacrylic acid propyl ester, and mixtures thereof.

12. The molded article according to claim 8, wherein said C₁-C₈ acrylic acid alkyl ester is acrylic acid ethyl ester.

13. The molded article according to claim 8, wherein said UV absorbent (E) is selected from the group consisting of:
benzotriazoles represented by Chemical Formula (III) 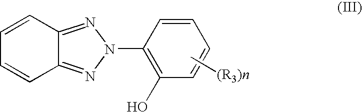
wherein R₃ is a C₁-C₁₀ alkyl group or alkyl-substituted phenyl and n is 1 or 2;
benzophenones represented by Chemical Formula (IV) 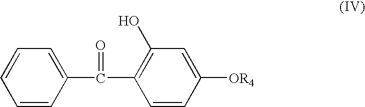
wherein R₄ is H, a C₁-C₁₅ alkyl group or alkyl-substituted phenyl;
triazines represented by Chemical Formula (V) 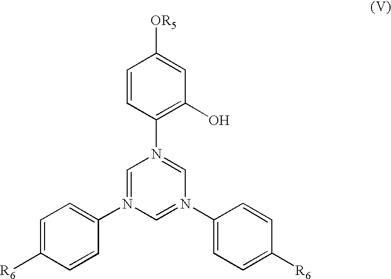
wherein R₅ is H, a C₁-C₁₈ alkyl group, a C₂-C₆ halogen-substituted alkyl group, a C₁-C₁₂ alkoxy group or benzyl group; and R₆ is H or methyl; and
mixtures thereof.

14. The molded article according to claim 8, further comprising up to about 60 parts by weight of an additive selected from the group consisting of fluorescent brighteners, flame retardants, flame retardant aids, lubricants, releasing agents, nuclear agents, anti-static agents, stabilizers, reinforcing agents, inorganic additives, pigments, dyes and mixtures thereof.
